(19) United States
(12) Patent Application Publication
(10) Pub. No.: US 2010/0156626 A1
(43) Pub. Date: Jun. 24, 2010

(54) Remote Telemetric Panic and Service Apparatus

(76) Inventor: Brian Story, Victorville, CA (US)

Correspondence Address: MICHAEL E. KLICPERA, PO BOX 573, LA JOLLA, CA, 92038-0573, US

(21) Appl. No.: 12/717,877

(22) Filed: Mar. 4, 2010

Related U.S. Application Data
(63) Continuation-in-part of application No. 12/077,832, filed on Mar. 20, 2008.
(60) Provisional application No. 60/919,324, filed on Mar. 20, 2007.

(51) Int. Cl. G08B 1/08; H04M 11/04

(52) U.S. Cl. 340/539.13; 455/404.2

(57) ABSTRACT

The present invention, a system utilizing an emergency command center, includes: a keychain or penchant body including within a GPS navigation means, an GPS antenna; a radio-frequency transmitter, a radio-frequency antenna; a power source, the present invention one or more buttons; wherein, when the one or more button are pressed, the radio-frequency receiver transmits a specific identifiable signal using telemetric technology to the emergency command center.

### CROSS-REFERENCES

The present application is a continuation-in-part of patent application Ser. No. 12/077,832 filed on Mar. 20, 2008 which claims priority to Provisional Application 60/919,324 filed on Mar. 20, 2007 both entitled “Wireless Security and Asset Management Control System” currently pending and also claims priority to Provisional Application 61/156,798 filed on Mar. 3, 2009 entitled “Radio-Frequency Controlled Panic Remote Transmitter System”. These applications are incorporated herein by this reference.

### FIELD OF THE INVENTION

This invention is generally related to personal security systems and more specifically to a remotely keychain, pendant or other commonly carried device that incorporates telemetric technology and one or more panic or service buttons for security and transportation service needs.

### BACKGROUND OF THE INVENTION

People are often exposed to dangerous or life threatening circumstances in or around their vehicle, when shopping, jogging, walking, and many other situations with no way to communicate their situation.

Existing GPS systems lack the telemetric capacity to communicate instantly through an RF transmitter to an independent emergency service and therefore are not considered a safety or security system.

As can be seen, there is a need for a system which allows an individual to communicate with an emergency call center by transmitting a RF signal to a global positioning system (GPS) device on their vehicle which in turn alerts the call center of a potential emergency situation.

### SUMMARY OF THE INVENTION

The present invention generally relates to telemetric technology which includes a radio transmitter and GPS navigation technology. More specifically the present invention is a remote telemetric technology panic and service button transmitter which either communicates an alert or necessary service to an emergency command center.

The present invention, a system utilizing an emergency command center, includes: a keychain or penchant body including within a GPS navigation means, an GPS antenna; a radio-frequency transmitter, a radio-frequency antenna; a power source, the present invention one or more buttons; wherein, when the one or more button are pressed, the radio-frequency receiver transmits a specific identifiable signal using telemetric technology to the emergency command center.

When the emergency call center receives a specific identifiable signal from the remote apparatus, it verifies the association of the identifiable information with its database and then places a call to the client's cell phone number associated with the specific signal to inquiry as to the emergency. If the cell phone is not answered, a priority one policy emergency is generated. If the client answered the cell phone, the emergency call center verifies that signal was not a panic situation associated with personal risks and then inquires as to the services or help needed.

These and other features, aspects and advantages of the present invention will become better understood with reference to the following drawings, description and claims.

### BRIEF DESCRIPTION OF THE DRAWINGS

FIG. 1 is a depicts a top view of an embodiment of an embodiment of the invention;

FIG. 2 is a depicts a side view of an embodiment of an embodiment of the invention;

FIG. 3 depicts of the circuit board for the present invention.

FIG. 4 depicts of the overall scene of a an attack of an client by an attacker;

FIG. 5 depicts the present invention with the client pushing the panic or service button;

FIG. 6 depicts the emergency call scene.

FIG. 7 depicts the flow chart of emergency call and service steps.

### DESCRIPTION OF THE PREFERRED EMBODIMENTS

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features. However, any single inventive feature may not address any of the problems discussed above or may only address one of the problems discussed above. Further, one or more of the problems discussed above may not be fully addressed by any of the features described below.

In one embodiment of the present invention generally allows an individual to communicate with an emergency call center by transmitting an RF signal and a GPS position which alerts the call command center of a potential emergency situation.

In another embodiment of the present invention generally allows an individual to communicate with an emergency call center by transmitting an RF signal and a GPS position which alerts the call command center of a necessary service situation.

When the emergency call center receives a unique signal from the remote transmitter, it verifies the association of the transmitter with its database and then places a call to the client's cell phone number associated with the unique signal to inquiry as to the emergency. If the cell phone is not answered, a priority one policy emergency is generated. If the client answered the cell phone, the emergency call center verifies that signal was not a panic situation associated with personal risks and then inquires as to the services or help needed. It is anticipated that activation means can be used with the present invention. For example, one or more buttons, which are pressed for a specific period of time, can be used to initiate the transfer of the signal to the emergency call center. Other means are anticipated by the Applicant, for example, the panic activation means could be a system where the keys are pulled out of the present invention, breaking a glass barrier, pulling a twisting a post into a specific position, and other such means.

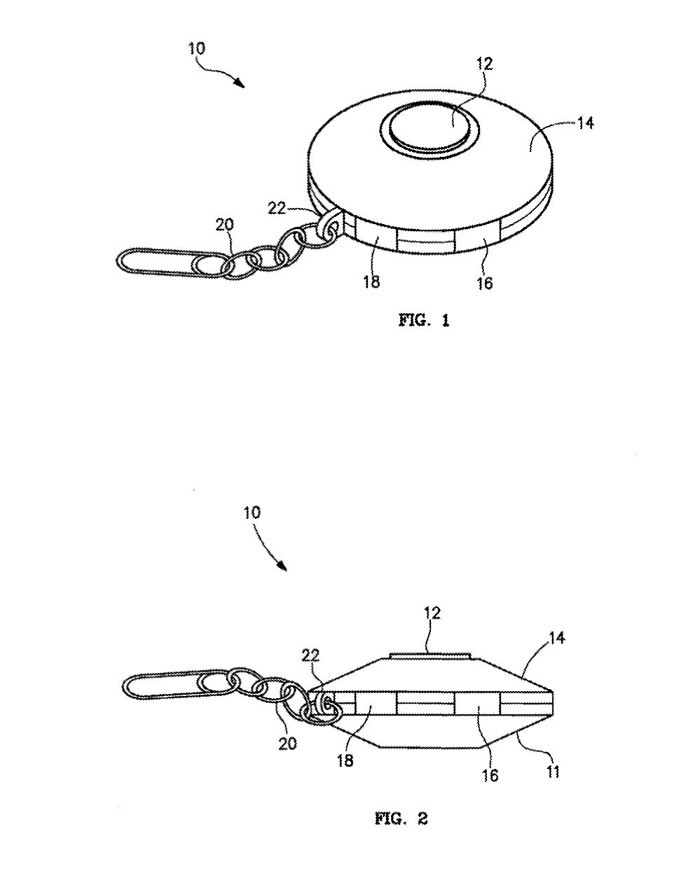

Referring to FIG. 1, an embodiment of the remote panic or service transmitter apparatus 10 is a device which uses telemetric, a new technology, which combines existing GPS and communications technology to form a hybrid safety and emergency or service notification system. The panic/service transmitter apparatus 10 is a small remote control device consisting of a substantially hard clam shell case having a top cover 14 and a bottom cover 11. It is anticipated by the Applicant the the clam shell case can be replaced with another configuration e.g. single case with sliding cover. Suitable materials for the top cover 14 and bottom cover 11, include, but are not limited to, PEEK (polyetheretherketone), Nylon, carbon fibers, Dacron, PVC, polycarbonate, synthetic polyamide, high density polypropylene, high density polyethylene, epoxies, polyesters, silicones, phenolics, Teflon (PTFE), expanded polytetrafluroethylene (e-PTFE), polyetheretherketone (PEEK), polyurethane, Pebax, Hytrel, polyethylene and ultra-high molecular weight fibers of polyethylene (UHMWPE) commercially available as Spectra™ or Dyneema™, as well as other high tensile strength materials such as Vectran™, or Kevlar™. In addition, additional suitable materials for the top cover 14 and the bottom cover 11 may include, but are not limited to, metallic materials such stainless steel, cobalt-chrome alloy, titanium, titanium alloy, or nickel-titanium shape memory alloys, among others. The top cover 14 and bottom cover can be fabricated by molding, machining or other suitable techniques. It is desirable for the panic/service transmitter 10 to be the appropriate size to function as a key chain or pendant or other item which encourages an individual to easily keep in personal possession. A power switch 16 is provided on the side of the panic/service apparatus 10. As shown, a panic button 12 is located on the top cover 14 and its operation will be discussed later in more detail. The panic/service apparatus may have addition buttons 18 that can have independent functions such as to send a signal for various services. Services could include, but not limited to, vehicle situations, such as flat tire repair, dead battery, lock or lost keys requiring remote key accessing, accident assistance, energy (e.g. gas) supplementation, navigation assistance, and traffic and weather assistance. Suitable materials for the power switch 16, the panic button 12 and the alternate service buttons 18 include, but are not limited to, PEEK (polyetheretherketone), Nylon, carbon fibers, Dacron, PVC, polycarbonate, synthetic polyamide, high density polypropylene, high density polyethylene, epoxies, polyesters, silicones, phenolics, Teflon (PTFE), expanded polytetrafluroethylene (e-PTFE), polyetheretherketone (PEEK), polyurethane, Pebax, Hytrel, polyethylene and ultra-high molecular weight fibers of polyethylene (UHMWPE) commercially available as Spectra™ or Dyneema™, as well as other high tensile strength materials such as Vectran™, or Kevlar™. In addition, additional suitable materials for power switch 16, the panic button 12 and the alternate service buttons 18 may include, but are not limited to, metallic materials such stainless steel, cobalt-chrome alloy, titanium, titanium alloy, or nickel-titanium shape memory alloys, among others. Generally the power switch 16, panic button 12 and alternate service buttons 18 are fabricated using molding or machining techniques, but other techniques are anticipated by the Applicant. The buttons are designed to protrude through voids or holes in or sandwiched between the top cover 14 and bottom cover 11 and are held in place generally using a shoulder that is bias by a spring contact but other technologies can be utilized.

Also shown on FIG. 1 is an ear 22 projecting outward from the present invention to engage a chain or other cable mechanism 20 for convenient attachment to keys, a purse, belt loop, or secure or non secure piece.

It is understood by those familiar with the technology that the RF transceiver 35 as well as its antenna 44, the GPS chip 34 with its antenna 42, and the microprocessor with instructional memory 32 and power source 38 will be incorporated within the top cover 14 and bottom cover of the present invention 10.

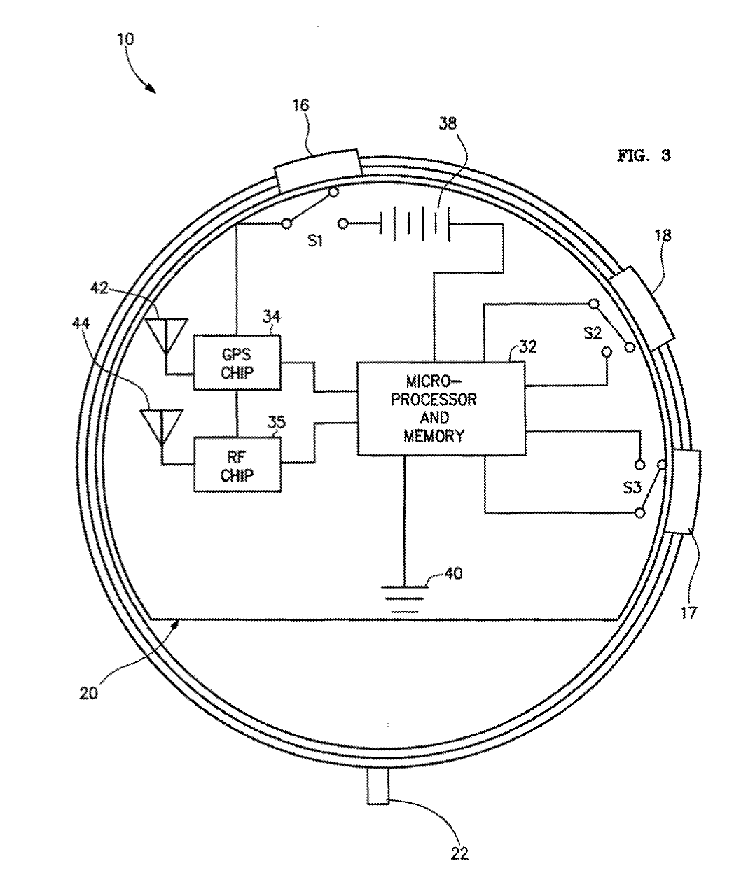

FIG. 2 is a depicts a side view of an embodiment of an embodiment of the invention. Shown is this side view is the top cover 14, bottom cover 11, panic button 12, power switch 16 and optional service button 18. Also shown is the ear 22 engaged to a chain or cable 20.

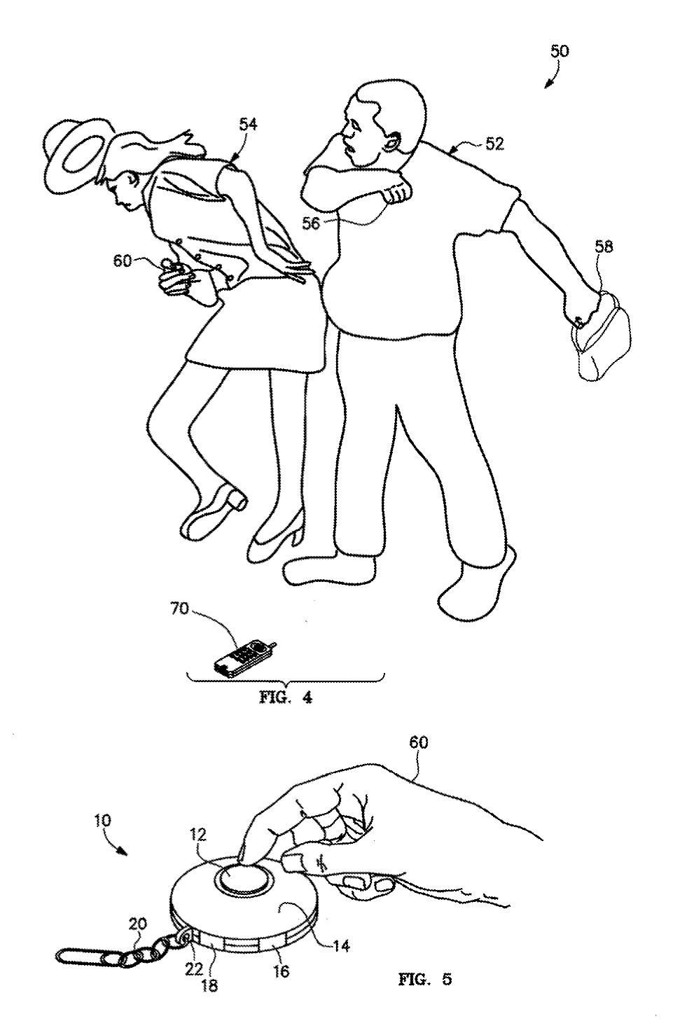

FIG. 3 depicts of the circuit board for the present invention.

As depicted in the FIG. 3, an embodiment of the present invention includes the following components:

GPS navigation chip 34
GPS antenna 42
RF transmitter chip 35
RF antenna 44
Microprocessor 32
Power source 38
Remote panic 12 and optional service buttons 18
Power button 16

The microprocessor monitors the activation of the buttons (panic or service) and performs timing sequences. Since false alarms are desired to be minimized, a button must be continuously depressed for a specific period, (e.g. 3 seconds) before the microprocessor determines that an event has taken place. If the microprocessor determines an event has taken place, it powers up the GPS chip and radio-frequency chip to begin a series of steps that are outlined in FIG. 7. Since a power-up delay in establishing a location by the GPS chip, the microprocessor can be programmed to periodically turn on the GPS chip to minimize the GPS power-up delay. Similarly, the radio-frequency chip may have a power-up delay and the microprocessor can be programmed to periodically turn on the radio-frequency chip to minimize the radio-frequency power-up delay. The microprocessor can also be used to monitor other buttons that signify other operations, e.g. service request. In addition, the microprocessor can perform other operations, like generating a digital clock/date that can be displayed on a small LCD or LED display on the present invention panic/service apparatus 10 (not shown). The power switch or button 16 is used to turn on and off to conserve energy when utilization of the panic/service apparatus 10 is not desired or necessary. The power source 38 typically is an electrical replaceable battery. Current standard batteries of the alkaline or oxyride generally provide the longest life and are thus desirable. Rechargeable batteries, such as the nickel-metal hydride or lithium can be utilized with the present invention and a charging port (not shown) can be included on the key chain or pendant body assembly for charging purposes, or the rechargeable batteries can be removed from the present invention 10 and charged in an appropriate apparatus.

Also shown in FIG. 3 are power switch 16, optional service buttons 18 and 17 are designed to engage Switch 1, Switch 2 and Switch 3, respectively. As shown the buttons protrude through voids or holes in or sandwiched between the top cover 14 and bottom cover 11 and are held in place generally using a shoulder that is bias by a spring (S1, S2 and S3) contact but other technologies can be utilized.

Also shown is the ear 22 designed for flexible attachment.

FIG. 4 depicts of the overall scene of an attack 50 on a client/subscriber 54 by an intruder/attacker 52. In this example, a man 52 has attacked a woman 54 and has taken possession of her purse 58. The woman has the hand holding present invention activating panic means 60 and her cell phone 70 is on the ground. This example is only exemplary as the client/subscriber 54 can be either a woman or a man, and the intruder/attacker can be either a man or a woman. Since the present invention has GPS tracking capability, as long as the woman has possession of the key chain or penchant present invention 10 the GPS continuously sends out a navigation location signal to the emergency center 84. In this scenario, when the emergency center 84 confirms the identifiable signal and then attempts to reach the client by the registered cell phone number on a database to the cell phone 70 and either she does not answer or it is anticipated by the Applicant that if answered, a predetermined word or phrase is spoken, then emergency control center can determine the appropriate response required and if necessary, will contact the appropriate authorities (e.g. a priority one call) will be generated. The emergency communication center 84 will have the continuous navigation location to communicate with the authorities. It is anticipated by the Applicant that the continuous navigation location can be communicated automatically to a remote computer means that the authorities possess which can be continuously updated.

FIG. 5 depicts the present invention 10 with the client 60 pushing a panic button 12. A person would use an embodiment of the invention by having the remote panic transmitter 10 in their possession, upon recognizing an emergency situation, presses the button on the remote panic transmitter 10 which sends a specific identifiable message to the emergency call center 84. When the emergency command center 84 calls the person on a cell phone, the emergency command center 84 can determine the appropriate response required. The emergency situation may not included an intruder, as the client may be experiencing a heart attack, asthma attack, or other emergency medical situation. Also possible is that by pushing the panic button 12 the emergency command center 84 will call the client/subscriber's cell phone and if the client/subscriber answers the cell phone, they may state that they vehicle or other services. Also shown but being pushed is the optional service button 18 which, together with the cell phone answer, can provide various services, such as, but not limited to, gas service, battery service, lost key assistance, accident help, flat tire, weather conditions, traffic conditions, navigation assistance, also possible is that by pushing the optional service button 18.

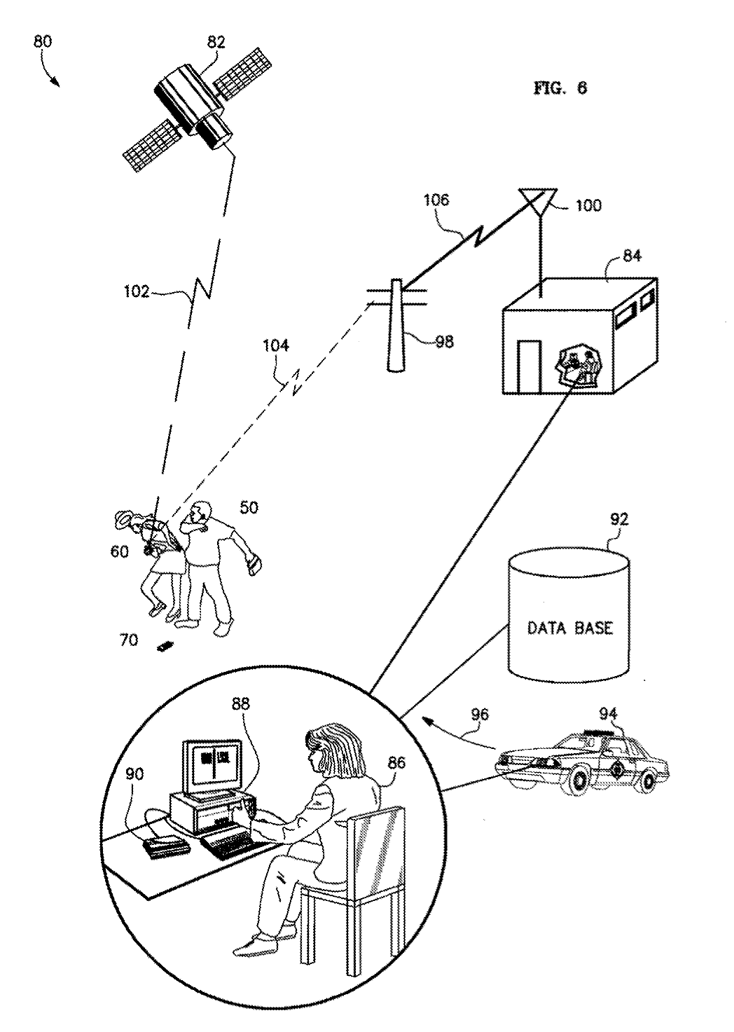

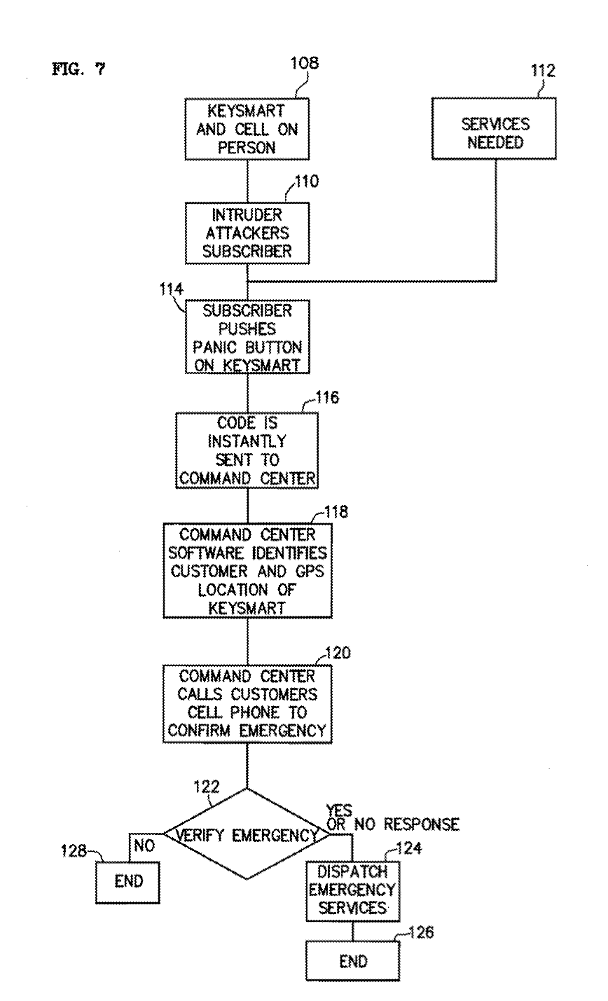

FIG. 6 depicts the emergency call scene 80. Shown is the overall scene of an attack 50 on a client/subscriber 54 by an intruder/attacker 52. In this example, a man 52 has attacked a woman 54 and has taken possession of her purse 58. The woman has her hand holding the present invention activating a panic means 60 whereby her cell phone 70 is on the ground and not in readily possession. Also shown is GPS satellite 82 communicating wirelessly 102 with the present invention 10 while simultaneously or sequentially where radio-frequency wireless communication 104 of a specific identifiable signal is communicating with the emergency command center 84 having a receiving means 100 which may communicate through various radio-frequency towers 98, e.g. cell phone towers. Also shown is emergency command center operator 86 analyzing the signal receiving and analyzing the data receive by modem, internet or intranet means 90 through computer 88. The emergency command center computer 88 utilizes a data base 92 which contains client/subscriber specific information such as, but not limited to, current client, specific identifiable signal, cell phone number, accounting information, personal client/subscriber information, etc. Also shown in FIG. 6. Is the government or private authorities e.g. local police or fire department 94, receiving a call from the emergency command center operator 86 stating that an personal emergency situation is currently underway and a emergency response 96, e.g. a priority one call, is conducted.

FIG. 7 depicts the flow chart of emergency call and service steps. In step 108 on the present invention panic/service apparatus 10 has its power switch 16 in the on position, and the individuals cell phone 70 is on. Both the present invention panic/service apparatus 10 and the cell phone are in possession of the individual. In step 110 an intruder in attacking the client/subscriber 54. In step 112, the client/subscriber 54 desires services or need assistance and this request can be distinguished from the panic situation either by 1) answered the cell phone 70 when called by the emergency communication center 84 and convey the services or assistance needed or 2) alternately another button can be incorporated that sends another identifiable signal. In step 114, the client/subscriber 54 is in an emergency situation and depresses the panic button for the required time period. In step 116 the specific identifiable signal or code is sent to the emergency communication center 84. In step 118 the emergency communication center 84 uses a database and software to identify the customer and GPS location. In step 120 the emergency command center 84 calls the client/subscriber 54 to confirm is an emergency or panic situation exists. In step 122, the emergency is verified by a no response or a predetermined word or phrase that is spoken and emergency services are dispatched 124 If the emergency situation is not verified, then the emergency command center dispatches necessary vehicle or personal services 128 such as such as, but not limited to, gas service, battery service, lost key assistance, accident help, flat tire, weather conditions, traffic conditions, navigation assistance.

In other embodiments, alternative functions could be supported by using the remote transmitter 10, such as concierge services or direction finding. These are not necessarily emergency services, but represent available services which could be accessed by the technology.

Even though numerous characteristics and advantages of various embodiments of the present invention have been set forth in the foregoing description, together with details of the structure and functions of various embodiments of the invention, this disclosure is illustrative only, and Changes may be made in detail, especially in matters of structure and arrangement of parts within the principles of the present invention to the full extent indicated by the broad general meaning of the terms expressed herein. It will be appreciated by those skilled in the art that the teachings of the present invention can be applied to other systems without departing from the scope and spirit of the present invention.

1. A remote telemetric apparatus utilizing an emergency command center comprising:
a body assembly representing a key chain, pendant or other object containing telemetric components, said body assembly including within it internal structure a GPS navigation chip with a GPS antenna, a RF transmitter chip with a RF antenna, a microprocessor, a power source, a power button, and one or more panic or service buttons thereby comprising a remote telemetric panic and service apparatus; and
wherein when one or more buttons are pressed for a predetermine time period, the remote telemetric panic and service apparatus sends a unique identifiable signal to said emergency command center.

2. A remote telemetric apparatus as recited in claim 1 wherein said emergency command center has established a communication with authorities for initiating rescue operations.

3. A remote telemetric apparatus as recited in claim 1 wherein said emergency command center resides in more than one location.

4. A remote telemetric apparatus as recited in claim 1 wherein a optional service button is included with said remote telemetric apparatus.

5. A remote telemetric apparatus as recited in claim 1 wherein said emergency command center maintains a database of current client or subscriber personal information.

6. A remote telemetric apparatus as recited in claim 1 whereby said radio-frequency communication may communicate with one or more cell or radio-frequency antennas.

7. A remote telemetric apparatus as recited in claim 1 whereby said unique identifiable signal to said emergency command center initiates a call to the client's or subscriber's cell phone.

8. A remote telemetric apparatus as recited in claim 1 whereby said emergency command center determines whether a personal emergency or non-personal emergency is established.

9. A remote telemetric apparatus as recited in claim 1 whereby said emergency command center established cell phone communication with said client or subscriber.

10. A remote telemetric apparatus as recited in claim 1 whereby b said non-personal emergency situation renders vehicular or personal services.
